(19) United States
(12) Patent Application Publication
(10) Pub. No.: US 2010/0100609 A1
(43) Pub. Date: Apr. 22, 2010

(54) SYSTEM AND METHOD FOR DIRECTING DISPLAY OF A STANDARD OPERATION PROCEDURE OF AN ITEM USING MULTIMEDIA DEVICES

(75) Inventors: ZONG-YUAN SUN, Tu-Cheng (TW); DA-HUA XIAO, Shenzhen City (CN); YAN-JUN WANG, Shenzhen City (CN); YI-LIANG XIAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/547,612

(22) Filed: Aug. 26, 2009

(30) Foreign Application Priority Data
Oct. 20, 2008 (CN) 200810305027.6

(51) Int. Cl. G06F 3/01; G06F 15/16

(52) U.S. Cl. 709/219; 715/705

(57) ABSTRACT

A method for directing display of a standard operation procedure of an item using multimedia devices positioned on at least one workbench that produces the item. The method divides the SOP into several instruction steps, assigns a corresponding identifier to each instruction step of the SOP, and sends a start command to multimedia devices. The method further downloads and directs a instruction step of the SOP having the same identifier with the multimedia device if the multimedia device receives the start command.

### BACKGROUND

1. Technical Field

Embodiments of the present disclosure relate to directing systems and methods, and particularly to a system and method for directing display of a standard operation procedure of an item using multimedia devices.

2. Description of Related Art

Generally speaking, a standard operation procedure (SOP) of an item are recorded on hardcopy manuals. These SOP hardcopy manuals may be placed on top or around workbenches/work areas for employees to follow. However, these SOP hardcopy manuals are often bulky, making them difficult to follow, especially if the SOP is complex.

### BRIEF DESCRIPTION OF THE DRAWINGS

FIG. 1 is a block diagram of one embodiment of a system for directing display of a standard operation procedure of an item using multimedia devices.

FIG. 2 is a schematic diagram illustrating one embodiment of a multimedia device in FIG. 1.

FIG. 3 is a block diagram of one embodiment of function modules of the server 1 in FIG. 1 and the multimedia device 3 in FIG. 2.

FIG. 4 illustrates a flowchart of one embodiment of a method for directing display of a standard operation procedure of an item using multimedia devices.

### DETAILED DESCRIPTION

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

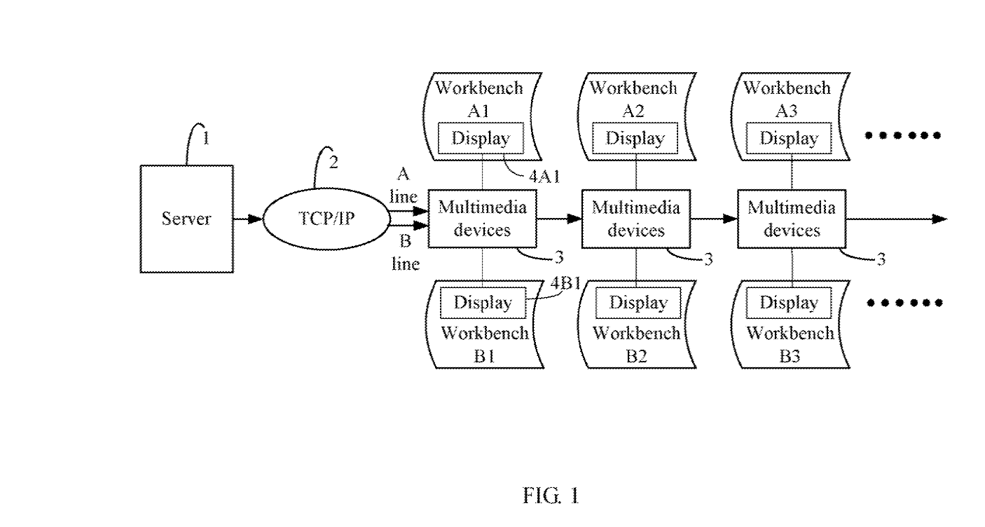

FIG. 1 is a block diagram of one embodiment of a system for directing display of a standard operation procedure of an item using multimedia devices. The system includes a server 1 and a plurality of multimedia devices 3 (only three shown) electronically connected to the server 1 via TCP/IP. The server 1 stores the standard operation procedure (SOP) of the item, information of at least one workbench that produces the item, and identifiers of the multimedia devices 3 positioned on the at least one workbench. The server 1 can service one or more production lines in a factory, the one or more production lines producing the same items. In one embodiment, as shown in FIG. 1, the server 1 servers two production lines, a production line A and a production line B. The production line A and production line B produce the same items.

Each of the multimedia devices 3 connects to one or more displays located at workbenches. The one or more displays are operable to display the same instruction step of the SOP simultaneously. In one embodiment, as shown in FIG. 1, the production line A and the production B are operable to produce the same item, where, the multimedia devices 3 directs a display 4A1 in the workbench A1 and a display 4B1 to display the same SOP on in workbench B1 at the same time.

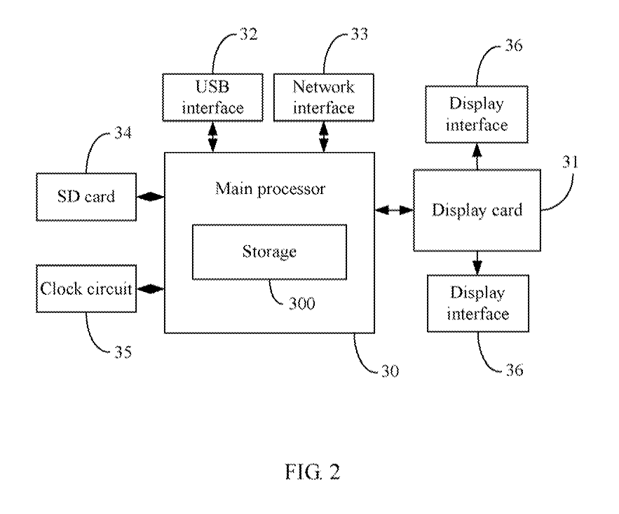

FIG. 2 is a schematic diagram illustrating one embodiment of a multimedia device 3 in FIG. 1. The multimedia device 3 includes two chips, a main processor 30 and a display card 31. The main processor 30 includes a storage 300, for storing a reproducing program to output the SOP via multimedia device 3. The display card 31 includes one or more displays interfaces 36 (only two shown) to connect to one or more displays.

In one embodiment, the multimedia device 3 further includes, but are not limited to, a universal serial bus (USB) interface 32, a network interface 33, a secure digital memory (SD) card 34, and a clock circuit 35. As an example, the multimedia device 3 may download the SOP from the server 1 via the USB interface 32 or the network interface 33, and saves the SOP in the SD card 34. The clock circuit 35 is used to display a date and time on the multimedia device 3. Depending on the embodiment, the multimedia device 3 may be connected to a mouse or a keyboard (not shown) via the USB interface 32.

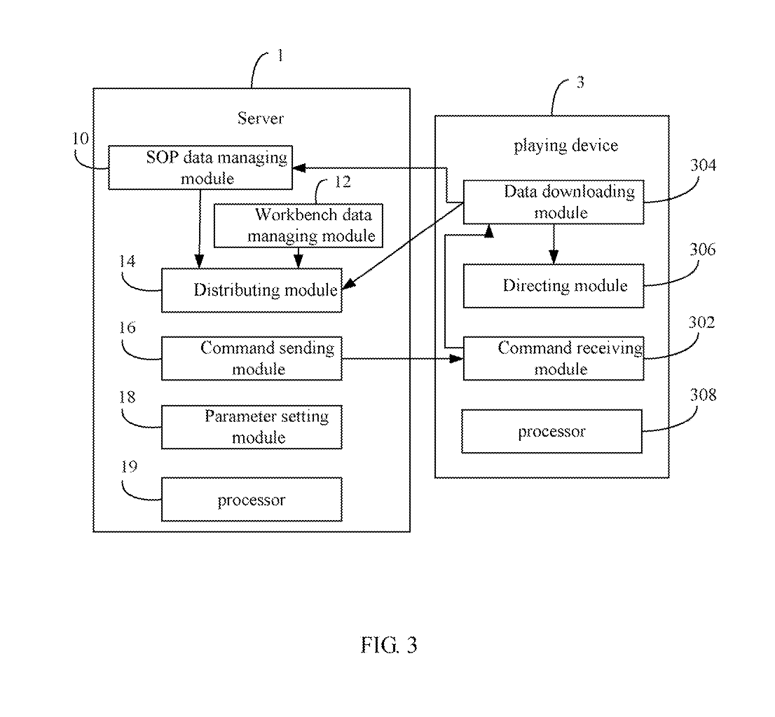

FIG. 3 is a block diagram of one embodiment of function modules of the server 1 in FIG. 1 and the multimedia device 3 in FIG. 2. In the embodiment of the present disclosure, the server 1 includes an SOP data managing module 10, a workbench data managing module 12, a distributing module 14, a command sending module 16, and a parameter setting module 18. In the embodiment of the present disclosure, the multimedia device 3 includes a command receiving module 302, a data downloading module 304, and a directing module 306. Depending on the embodiment, the server 1 may include one or more specialized or general purpose processors, such as a processor 19 for executing at least one operation for the modules 10-18. The multimedia device 3 may include one or more specialized or general purpose processors, such as the processor 308 for executing at least one operation for the modules 302-306.

The SOP data managing module 10 is operable to store the SOP of the item. The SOP may be an image formatted file (e.g., GIF, JPEG, PNG) or a video formatted file (e.g., MPEG, AVI, MOV, WMV), in one example.

The workbench data managing module 12 is operable to store information of the at least one workbench that produces the item and the identifiers of the multimedia devices 3 located on the at least one workbench. The workbench data includes a name of each workbench and a total workbench count. Each of the multimedia devices 3 has an unique identifier, such as “multimedia device 01”.

The distributing module 14 is operable to divide the SOP into several instruction steps according to the information of the at least one workbench, and assign a corresponding identifiers to each instruction step of the SOP. As an example, if the production line A has five workbenches, a workbench 1, a workbench 2, a workbench 3, a workbench 4, and a workbench 5. Then, the distributing module 14 divides the SOP into five instruction steps, an instruction step 1, an instruction step 2, an instruction step 3, an instruction step 4, and an instruction step 5. The instruction step 1 relates to operation instruction of workbench 1, the instruction step 2 relates to operation instruction of workbench 2, the instruction step 3 relates to operation instruction of workbench 3, the instruction step 4 relates to operation instruction of workbench 4, and the instruction step 5 relates to operation instruction of workbench 5.

The commanding sending module 16 is operable to send a start command to each of the multimedia devices 3. The start command is operable to control the multimedia devices 3 to direct the instruction step of the SOP according to the start command.

The parameter setting module 18 is operable to convert the SOP into the image formatted file or the video formatted file if the SOP is not in the image format or the video format.

The command receiving module 302 is operable to receive the start command from the server 1.

The data downloading module 304 is operable to download an instruction step of the SOP assigned with the same identifier of the multimedia device 3 if the multimedia device 3 receives the start command.

The directing module 306 is operable to direct the instruction step of the SOP in the multimedia device 3. As mentioned above, the multimedia devices 3 connects to one or more displays, which direct the instruction step of the SOP at the same time.

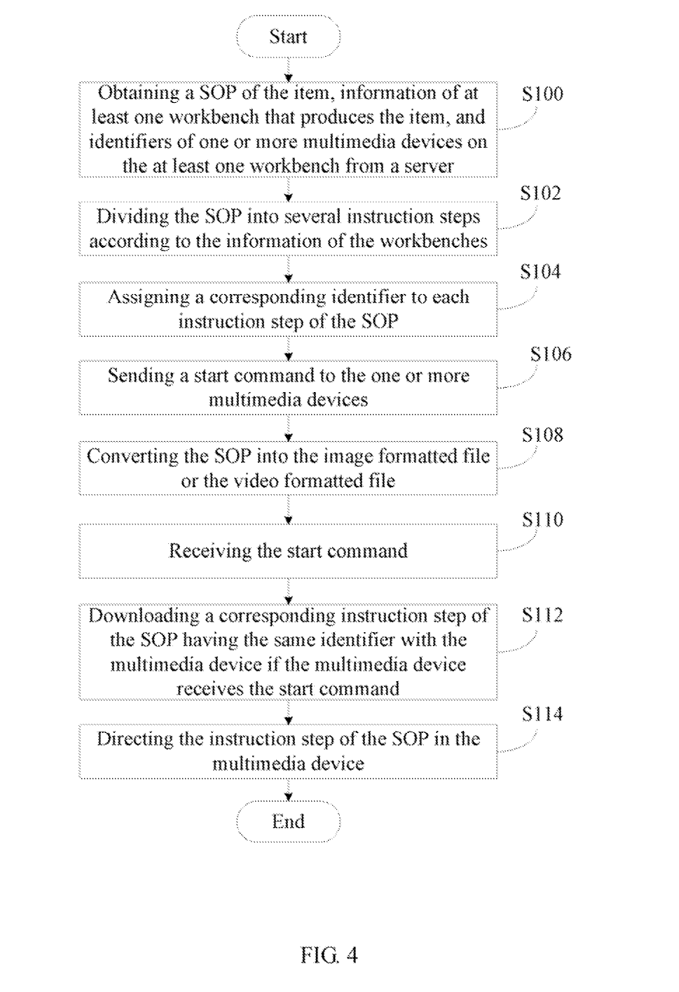

FIG. 4 illustrates a flowchart of one embodiment of a method for directing display of a standard operation procedure of an item using multimedia devices.

In block S100, the SOP data managing module 10 stores an SOP of the item, the workbench data managing module 12 stores information of at least one workbench that produces the item, and the identifiers of the multimedia devices 3 on the at least one workbench.

In block S102, the distributing module 14 divides the SOP into several instruction steps according to the information of the at least one workbench.

In block S104, the distributing module 14 assigns a corresponding identifier to each instruction step of the SOP.

In block S106, the command sending module 16 sends a start command to the multimedia devices 3. The start command is operable to control the multimedia devices 3 to direct the instruction step of the SOP according to the start command.

In block S108, the parameter setting module 18 converts the SOP into the image formatted file or the video formatted file if the SOP is not in the image format or the video format.

In block S110, the command receiving module 302 receives the start command from the server 1.

In block S112, the data downloading module 304 downloads a corresponding instruction step of the SOP assigned with the same identifier of the multimedia device 3 if the multimedia device 3 receives the start command.

In block S114, the directing module 306 directs the instruction step of the SOP in the multimedia device 3. Each of the multimedia devices 3 connects to one or more displays, which direct the instruction step of the SOP at the same time.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A server for directing display of a standard operation procedure (SOP) of an item using multimedia devices positioned on at least one workbench that produces the item, the server being electronically connected to the multimedia devices, the server comprising:
at least one processor to execute one or more programs, the one or more programs comprising:
an SOP data managing module operable to store the SOP of the item;
a workbench data managing module operable to store information of the at least one workbench, and identifiers of the multimedia devices positioned on the at least one workbench;
a distributing module operable to divide the SOP into several instruction steps according to the information of the at least one workbench, and assign a corresponding identifier to each instruction step of the SOP; and
a commanding sending module operable to send a start command to the multimedia devices, so as to control the multimedia devices to direct the instruction step of the SOP according to the start command.

2. The server as claimed in claim 1, wherein each of the multimedia devices comprises:
a data downloading module operable to download a corresponding instruction step of the SOP assigned with the same identifier of the multimedia device if the multimedia device receives the start command; and
a directing module operable to direct the instruction step of the SOP in the multimedia device.

3. The server of claim 2, wherein each of the multimedia devices connects to one or more displays.

4. The server of claim 3, wherein each of the multimedia devices is operable to direct more than one same instruction step of the SOP on the displays at the same time.

5. The server of claim 1, wherein the SOP is an image formatted file or a video formatted file.

6. The server of claim 5, further comprising a parameter setting module operable to convert the SOP into the image formatted file or the video formatted file if the SOP is not in the image format or the video format.

7. A computer-implemented method for directing display of a standard operation procedure (SOP) of an item using multimedia devices positioned on at least one workbench that produces the item, the method comprising:
obtaining the SOP of the item, information of the at least one workbench, and identifiers of the multimedia devices positioned on the at least one workbench from a server;
dividing the SOP into several instruction steps according to the information of the at least one workbench;
assigning a corresponding identifier to each instruction step of the SOP;
sending a start command to the multimedia devices;
downloading a corresponding instruction step of the SOP assigned with the same identifier of the multimedia device if the multimedia device receives the start command; and
directing the instruction step of the SOP in the multimedia device.

8. The method of claim 7, wherein each of the multimedia devices connects to one or more displays.

9. The method of claim 8, wherein each of the multimedia devices is operable to direct more than one same instruction step of the SOP on the displays at the same time.

10. The method of claim 7, wherein the SOP is an image formatted file or a video formatted file.

11. The method of claim 10, further comprising:
converting the SOP into the image formatted file or the video formatted file if the SOP is not in the image format or the video format.

12. A computer-readable medium having stored thereon instructions that, when executed by a computerized device, cause the computerized device to execute a computer-implemented method for directing display of a standard operation procedure (SOP) of an item using multimedia devices positioned on at least one workbench that produces the item, the method comprising:
obtaining the SOP of the item, information of the at least one workbench, and identifiers of the multimedia devices positioned on the at least one workbench from a server;
dividing the SOP into several instruction steps according to the information of the at least one workbench;
assigning a corresponding identifier to each instruction step of the SOP;
sending a start command to the multimedia devices;
downloading a corresponding instruction step of the SOP assigned with the same identifier of the multimedia device if the multimedia device receives the start command; and
directing the instruction step of the SOP in the multimedia device.

13. The medium of claim 12, wherein each of the multimedia devices connects to one or more displays.

14. The medium of claim 13, wherein each of the multimedia devices is operable to direct more than one same instruction step of the SOP on the displays at the same time.

15. The medium of claim 12, wherein the SOP is an image formatted file or a video formatted file.

16. The medium of claim 15, further comprising:
converting the SOP into the image formatted file or the video formatted file if the SOP is not in the image format or the video format.
